(19) United States
(12) Patent Application Publication
(10) Pub. No.: US 2010/0290375 A1
(43) Pub. Date: Nov. 18, 2010

(54) METHODS AND SYSTEMS FOR RANGING AND NETWORK ENTRY GROUP SWITCHING IN FDD WIMAX NETWORKS

(75) Inventors: Tom Chin, San Diego, CA (US); Guangming Shi, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/778,042

(22) Filed: May 11, 2010

Related U.S. Application Data
(60) Provisional application No. 61/178,948, filed on May 16, 2009.

(51) Int. Cl. H04W 36/00; H04J 1/00

(52) U.S. Cl. 370/281; 370/331

(57) ABSTRACT

Certain embodiments of the present disclosure provide a method for changing an FDD group during ranging or network entry procedures for the frequency division duplex (FDD) WiMAX systems.

### CLAIM OF PRIORITY

This application for patent claims the benefit of priority from U.S. Provisional Patent Application Ser. No. 61/178,948, entitled “Methods and Systems for Group Switching in Ranging and Network Entry for the FDD WIMAX Networks” and filed May 16, 2009, which is assigned to the assignee of this application and is fully incorporated herein by reference for all purposes.

### TECHNICAL FIELD

Certain embodiments of the present disclosure generally relate to wireless communication and, more particularly, to switching a frequency division duplex (FDD) group in ranging and network entry for WIMAX systems.

### SUMMARY

Certain embodiments of the present disclosure provide a method for wireless communications. The method generally includes identifying a first frequency division duplex (FDD) group to communicate with the base station, sending a request to a base station to join the first FDD group, receiving a request from the base station to switch to a second FDD group, switching to the second FDD group in response to the received request, and continuing the communication with the base station in the second FDD group.

Certain embodiments of the present disclosure provide an apparatus for wireless communications. The apparatus generally includes logic for identifying a first frequency division duplex (FDD) group to communicate with the base station, logic for sending a request to a base station to join the first FDD group, logic for receiving a request from the base station to switch to a second FDD group, logic for switching to the second FDD group in response to the received request, and logic for continuing the communication with the base station in the second FDD group.

Certain embodiments of the present disclosure provide an apparatus for wireless communications. The apparatus generally includes means for identifying a first frequency division duplex (FDD) group to communicate with the base station, means for sending a request to a base station to join the first FDD group, means for receiving a request from the base station to switch to a second FDD group, means for switching to the second FDD group in response to the received request, and means for continuing the communication with the base station in the second FDD group.

Certain embodiments of the present disclosure provide a computer-program storage apparatus for wireless communications, comprising one or more memories having instructions stored thereon, the instructions being executable by one or more processors. The instructions generally include instructions for identifying a first frequency division duplex (FDD) group to communicate with the base station, instructions for sending a request to a base station to join the first FDD group, instructions for receiving a request from the base station to switch to a second FDD group, instructions for switching to the second FDD group in response to the received request, and instructions for continuing the communication with the base station in the second FDD group.

Certain embodiments of the present disclosure provide a method for wireless communications. The method generally includes receiving a request to join a first frequency division duplex (FDD) group from a mobile station (MS), notifying the MS to switch to a second FDD group if number of mobile stations in the first FDD group is larger than a threshold, and communicating with the mobile station in the second FDD group.

Certain embodiments of the present disclosure provide an apparatus for wireless communications. The apparatus generally includes logic for receiving a request to join a first frequency division duplex (FDD) group from a mobile station (MS), logic for notifying the MS to switch to a second FDD group if number of mobile stations in the first FDD group is larger than a threshold, and logic for communicating with the mobile station in the second FDD group.

Certain embodiments of the present disclosure provide an apparatus for wireless communications. The apparatus generally includes means for receiving a request to join a first frequency division duplex (FDD) group from a mobile station (MS), means for notifying the MS to switch to a second FDD group if number of mobile stations in the first FDD group is larger than a threshold, and means for communicating with the mobile station in the second FDD group.

Certain embodiments of the present disclosure provide a computer-program storage apparatus for wireless communications, comprising one or more memories having instructions stored thereon, the instructions being executable by one or more processors. The instructions generally include instructions for receiving a request to join a first frequency division duplex (FDD) group from a mobile station (MS), instructions for notifying the MS to switch to a second FDD group if number of mobile stations in the first FDD group is larger than a threshold, and instructions for communicating with the mobile station in the second FDD group.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates an example frame structure in frequency division duplex (FDD) mode in the Worldwide Interoperability for Microwave Access (WiMAX) standard.

FIG. 5 illustrates example operations for changing a frequency division duplex (FDD) group, in accordance with certain embodiments of the present disclosure.

FIG. 5A illustrates example components capable of performing the operations shown in FIG. 5.

FIG. 6 illustrates an example table containing the current and proposed fields in a MOB_BSHO-REQ/RSP message, in accordance with certain embodiments of the present disclosure.

FIG. 7 illustrates an example procedure for switching to H-FDD group 2 during network reentry, in accordance with certain embodiments of the present disclosure.

FIG. 8 illustrates an example table containing the current and proposed fields in a Mobile Paging-Advertisement (MOB_PAG-ADV) message, in accordance with certain embodiments of the present disclosure.

FIG. 9 illustrates an example procedure for switching to H-FDD group 2 during network reentry or location update procedures, in accordance with certain embodiments of the present disclosure.

FIG. 10 illustrates an example table containing the current and proposed fields in a ranging response (RNG-RSP) message, in accordance with certain embodiments of the present disclosure.

FIG. 11 illustrates an example procedure for starting the initial ranging in H-FDD group 1 and switching to H-FDD group 2 to continue the initial ranging procedure or perform network reentry procedure, in accordance with certain embodiments of the present disclosure.

FIG. 12 illustrates an example table containing the current and proposed fields in a MOBILE_SCANNING INTERVAL ALLOCATION RESPONSE (MOB_SCN-RSP) message, in accordance with certain embodiments of the present disclosure.

FIG. 13 illustrates an example procedure for switching the H-FDD group during association ranging, in accordance with certain embodiments of the present disclosure.

### DETAILED DESCRIPTION

The Worldwide Interoperability for Microwave Access (WiMAX) standard provides FDD (Frequency Division Duplex) in addition to the TDD (Time Division Duplex) modes of operation for a mobile station (MS). The mobile station can perform initial network entry and network reentry procedures.

According to the current standards, an MS should perform initial network entry or network reentry procedures using the resources in H-FDD group 1. Therefore, the MS should receive on the first downlink (DL) subframe and transmit on the second uplink (UL) subframe. However, this requirement can create inflexibility when there is overload conditions in the ranging channel of the first H-FDD group and degrade the performance (e.g., more collision probability or more delay).

Although the WiMAX standard allows the MS to switch to another group by Group Switch IE in the MAP message, there are still limitations. As an example, initial ranging is anonymous and Group Switch IE is destined to a particular Basic CID of the half duplex (H-FDD) MS. Therefore, the MS should remain in the ranging channel of the current H-FDD group 1 until the end of ranging procedure when MS is given the Basic CID before Group Switch IE can be sent. In addition, for a full duplex-FDD mobile station, the network cannot control the H-FDD group for transmitting the ranging code.

Certain embodiments of the current disclosure provide techniques in which the base station commands the change of the H-FDD group during the ranging and network entry procedure in order to balance the loading on the ranging channel and DL/UL subframe resources.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system that uses orthogonal multiplexing schemes is a 3rd Generation Partnership Project (3GPP) Long Term Evolution (LTE) system. For downlink, LTE uses OFDM, and for uplink, LTE uses SC-FDMA. LTE also supports FDD, which may utilize certain embodiments of the present disclosure.

Another example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

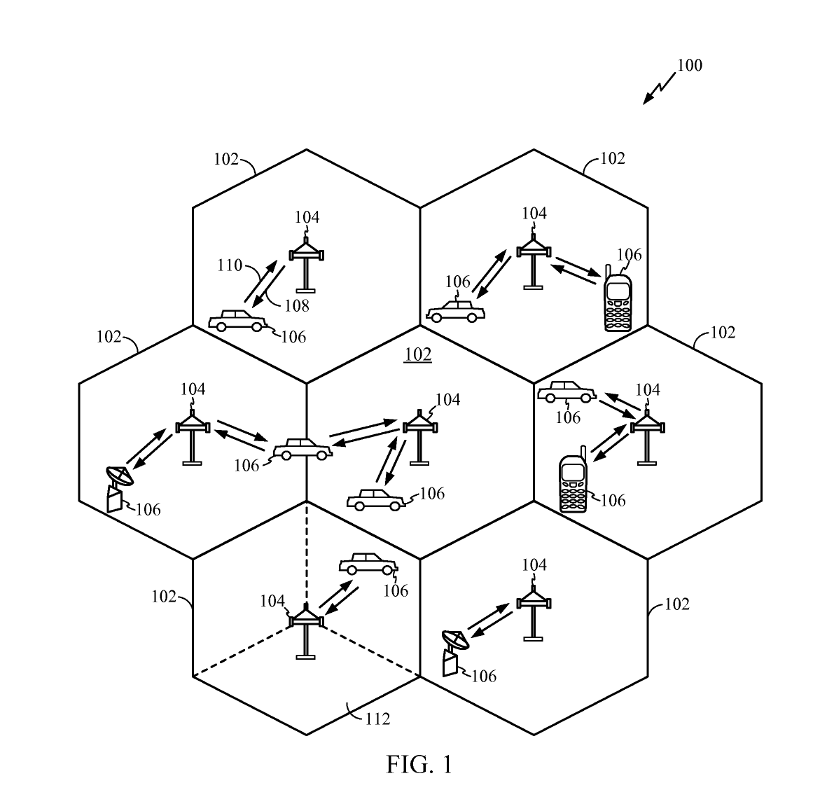

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

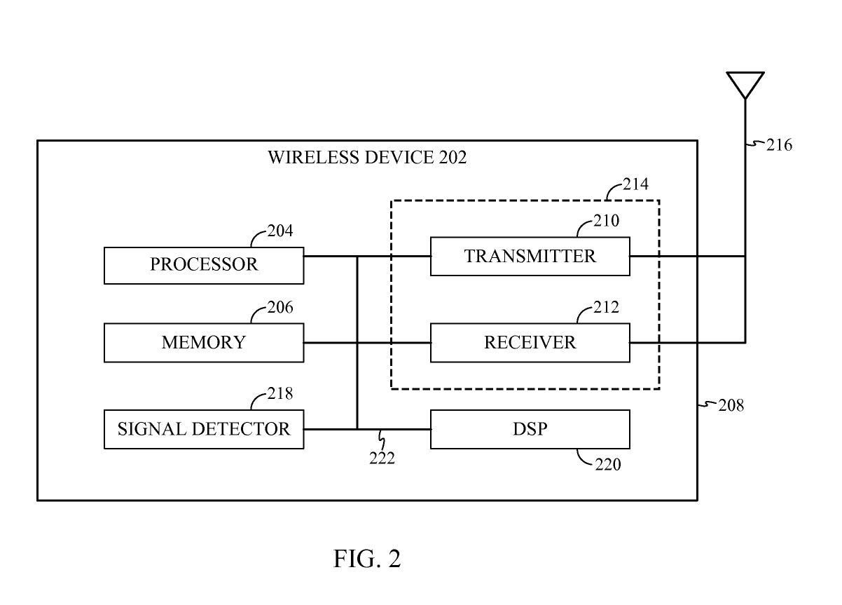

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

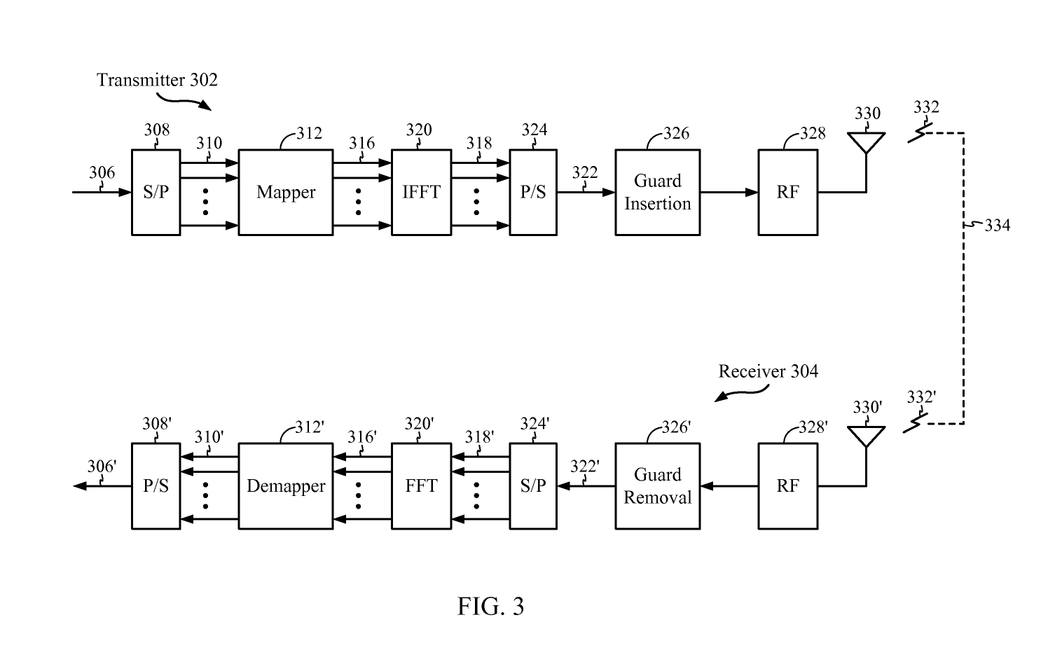

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to Nₑₚ (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Group Switching for Ranging and Network Entry in FDD Networks

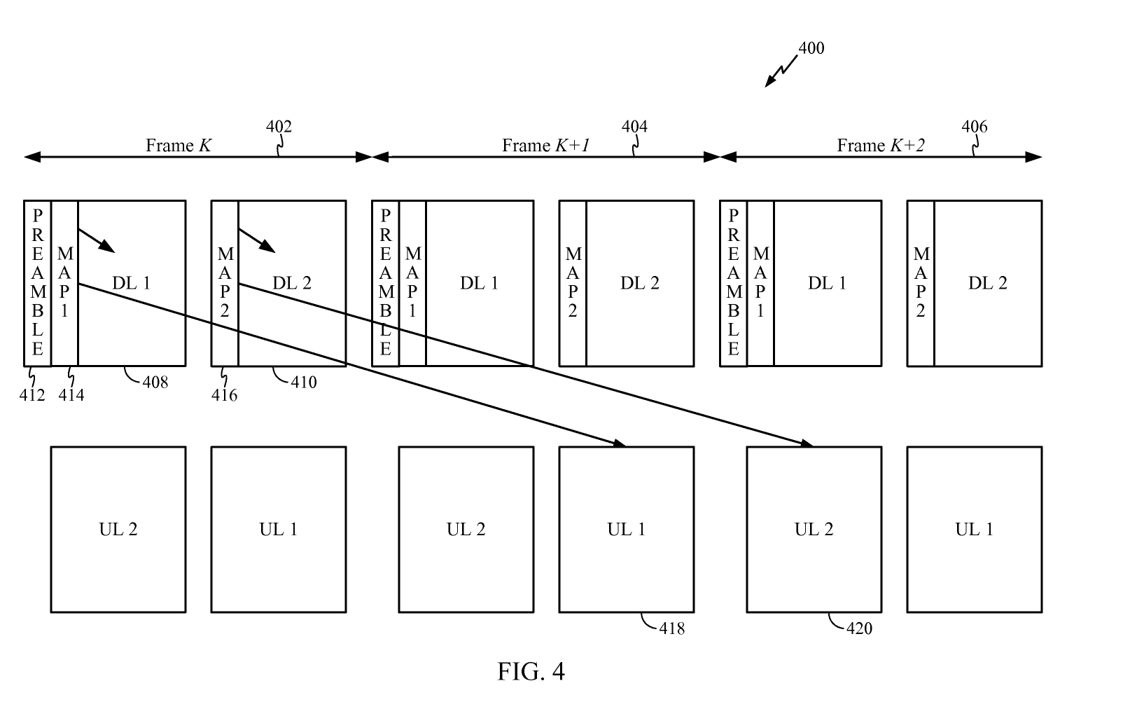

The WiMAX standard provides FDD (Frequency Division Duplex) in addition to the TDD (Time Division Duplex) operation of mobile stations. FIG. 4 illustrates a frame structure for FDD operation. The downlink (DL) and uplink (UL) may operate on different frequencies. Each DL part of the frame is divided into two groups, in which group 1 leads group 2. Each UL part of the frame is divided into two groups, in which group 2 leads group 1. The first DL subframe includes preamble 412, FCH1 (Frame Control Header 1), DL MAP1, UL MAP2, DCD (Downlink Channel Descriptor) and UCD (Uplink Channel Descriptor) fields. The second DL subframe includes FCH2 and DL MAP2, UL MAP2, DCD and UCD fields.

Each group of resources may be allocated independently. The DL MAP1 414 of frame K 402 allocates the data bursts of the first DL subframe 408 of frame K 402 and UL MAP 1 of frame K 402 allocates the data bursts of the second UL subframe 418 of frame K+1 404. The DL MAP2 416 of frame K 402 allocates the data bursts of the second DL subframe 410 of frame K and UL MAP2 of frame K allocates the data bursts of the first UL subframe 420 of frame K+2 406. DCD and UCD of these two groups are the same.

According to certain aspects, a mobile station (MS) may have one of the two possible capabilities: H-FDD (Half-Duplex Frequency Division Duplex) or F-FDD (Full-Duplex Frequency Division Duplex). In the F-FDD mode, an MS can transmit and receive in both of the two groups. In H-FDD mode, an MS can transmit and receive in only one of two H-FDD groups.

According to certain aspects, a mobile station may perform a few initial network entry and network reentry procedures such as handover reentry, network initiated network reentry or location update in idle mode, MS-initiated network reentry or location update in idle mode, associating ranging in scanning, and initial ranging.

In handover reentry, the MS performs network reentry procedure with the target BS by sending the handover ranging code or the ranging required RNG-REQ message on the bandwidth allocated by the Fast Ranging IE.

In network initiated network reentry or location update in idle mode, upon receiving the Mobile Paging Advertisement (MOB_PAG-ADV) message, an MS performs the network reentry or location update ranging procedure with the serving BS by sending contention-based initial ranging code or dedicated ranging code indicated by the MOB_PAG-ADV message.

In MS-initiated network reentry or location update in idle mode, an MS may perform the network reentry or location update ranging procedure with the current serving BS by sending contention-based initial ranging code.

In associating ranging in scanning, an MS performs associated ranging on one or more neighbor BSs in scanning using contention based initial ranging or dedicated ranging. In initial ranging, an MS performs the initial ranging in initial network entry.

According to the current standards, an MS may perform initial network entry or network reentry procedures using the resources in H-FDD group 1. Therefore, MS should receive on the first DL subframe and transmit on the second UL subframe. However, this requirement may create inflexibility when there is overload condition in the ranging channel of the first H-FDD group and degrade the performance, e.g., more collision probability or more delay.

Although the WiMAX standard allows an MS to switch to another group by Group Switch IE in the MAP message, the WiMAX standard still has the following limitations: Initial ranging is anonymous and Group Switch IE is destined to a particular Basic CID of the H-FDD MS. Therefore, MS should remain in the ranging channel of the current H-FDD group 1 until the end of ranging procedure when the MS is given the Basic CID before Group Switch IE can be sent. In addition, for an F-FDD mobile station, the network cannot control the H-FDD group for transmitting the ranging code.

According to certain aspects of the present disclosure, techniques are provided that may help to overcome to the above limitations by BS commanding the MS to change the H-FDD group during the ranging and network entry procedure in order to balance the loading on the ranging channel and DL/UL subframe resources. A few methods are proposed to change the H-FDD group index for H-FDD and F-FDD mobile station.

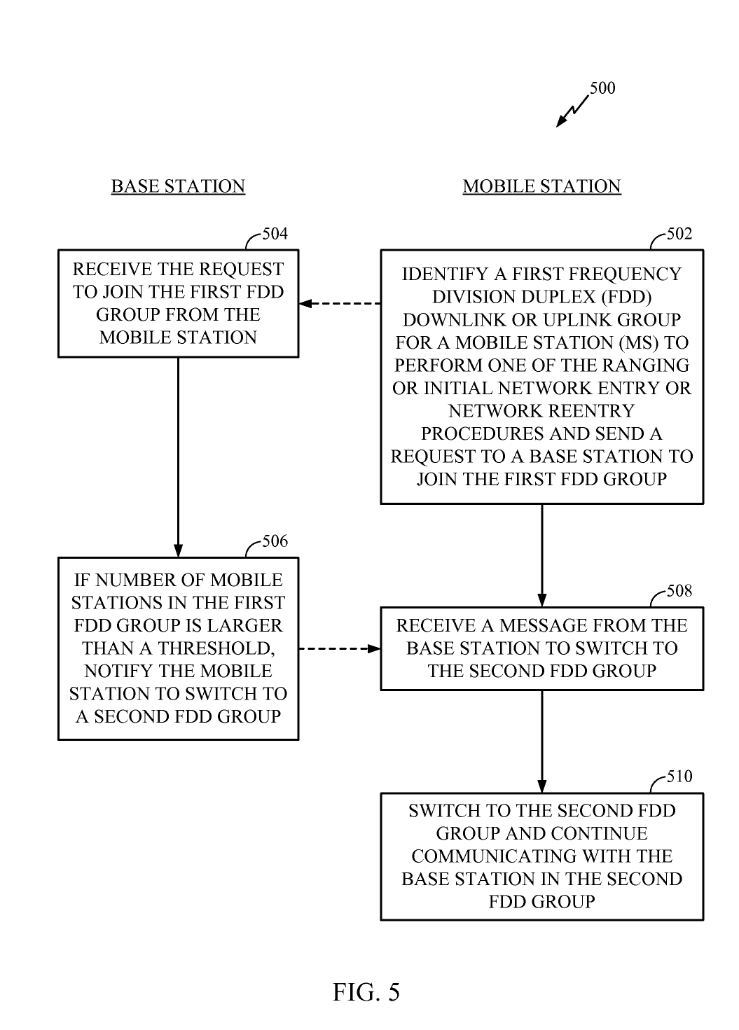

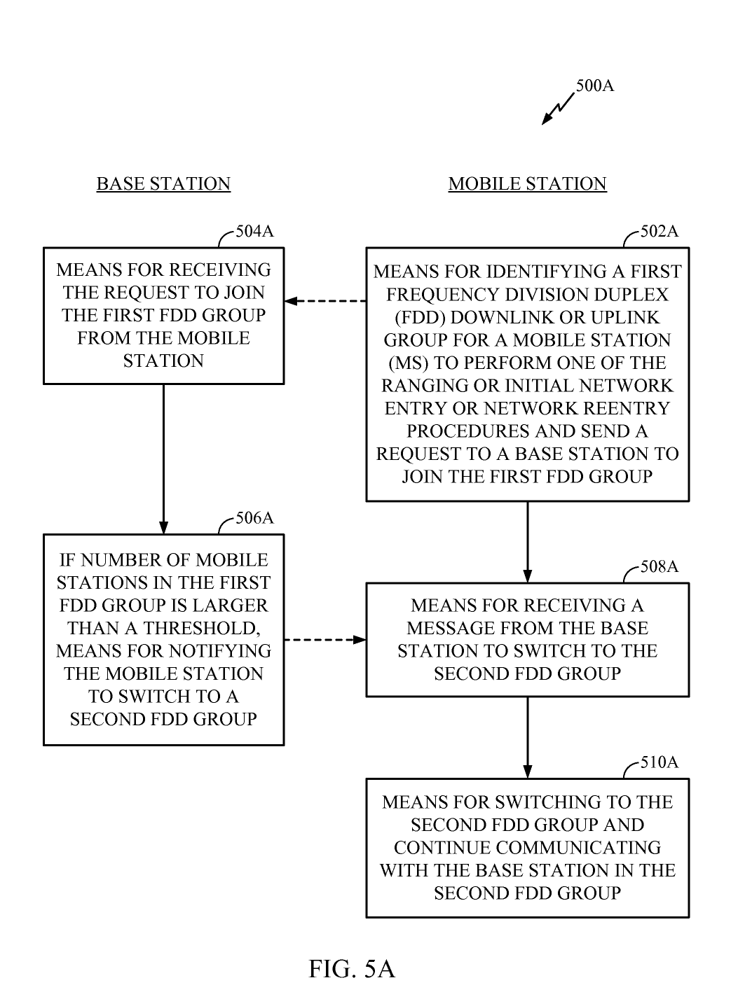

FIG. 5 illustrates example operations for changing a frequency division duplex (FDD) group, in accordance with certain embodiments of the present disclosure. For example, operations 502, 508, and 510 may be performed by an MS, while operations 504 and 506 may be performed by a BS.

At 502, an MS identifies a first FDD downlink or uplink group for a mobile station to perform one of the ranging or initial network entry or network reentry procedures and sends a request to a base station to join the first group. At 504, a base station receives the request to join the first FDD group from the mobile station. At 506, if a number of mobile stations in the first FDD group is larger than a threshold, the base station notifies the mobile station to switch to a second FDD group. At 508, the mobile station receives a message from the base station to switch to the second FDD group. At 510, the mobile station switches to the second FDD group and continues to communicate with the base station in the second FDD group.

For certain embodiments of the present disclosure, an MS may change the group in Handover Network Reentry. The serving BS may allow the MS to switch the H-FDD group to perform network reentry for the target BS using a base station handover request (MOB_BSHO-REQ) message and/or a base station handover response (MOB_BSHO-RSP) message.

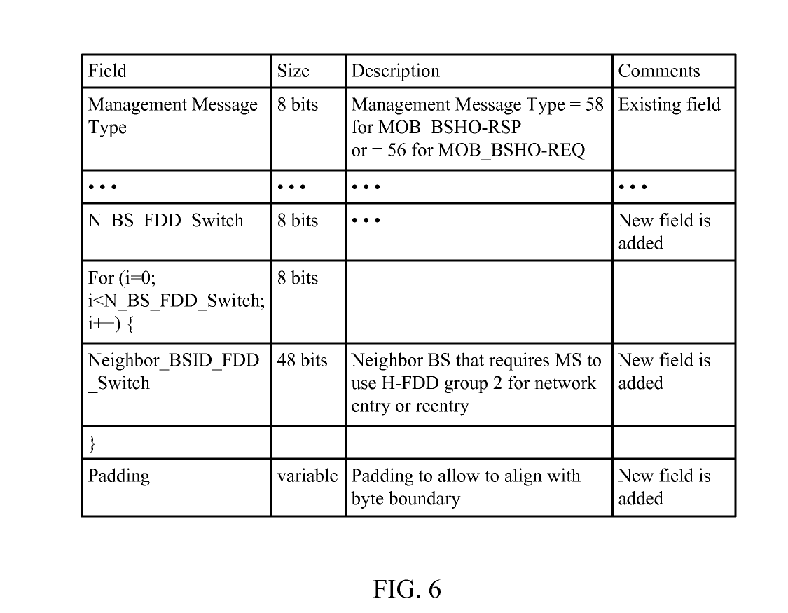

FIG. 6 illustrates an example table containing some of the current and proposed fields in the MOB_BSHO-REQ/RSP message, in accordance with certain embodiments of the present disclosure.

It may be noted that, in the example illustrated in FIG. 6, the field Neighbor_BSID_FDD_Switch indicates the neighbor BS that needs to use the H-FDD group 2 for initial network entry and reentry. If Neighbor_BSID_FDD_Switch is not specified, the MS will use H-FDD group 1 per the current standards specification.

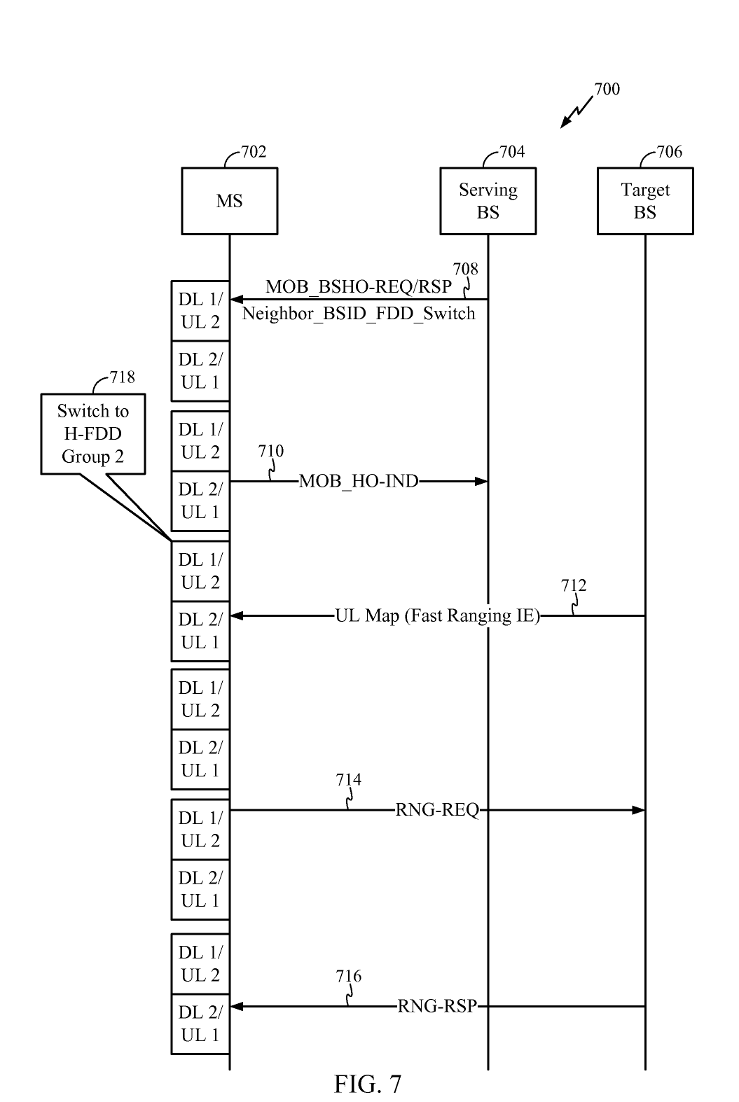

FIG. 7 illustrates a procedure in which an MS 702 can switch to H-FDD group 2 to receive Fast Ranging IE message 712 to send the RNG-REQ message 714. The serving BS 704 sends a MOB_BSHO-REQ/RSP message including a Neighbor_BSID_FDD_Switch field 708 to the mobile station 702. The MS sends a MOB_HO-IND message 710 to the base station. The MS switches to H-FDD group 2 718 and receives a ULMAP (Fast Ranging IE) message 712 from the target base station 706. The MS continues the ranging procedure with the target BS by sending the RNG-REQ message 714 and receiving RNG-RSP message 716 from the target BS.

For certain embodiments of the present disclosure, an MS may change the group in network initiated network reentry or location update in idle mode. The serving BS may switch the H-FDD group of MS to perform ranging or initial network entry in the MOB_PAG-ADV message.

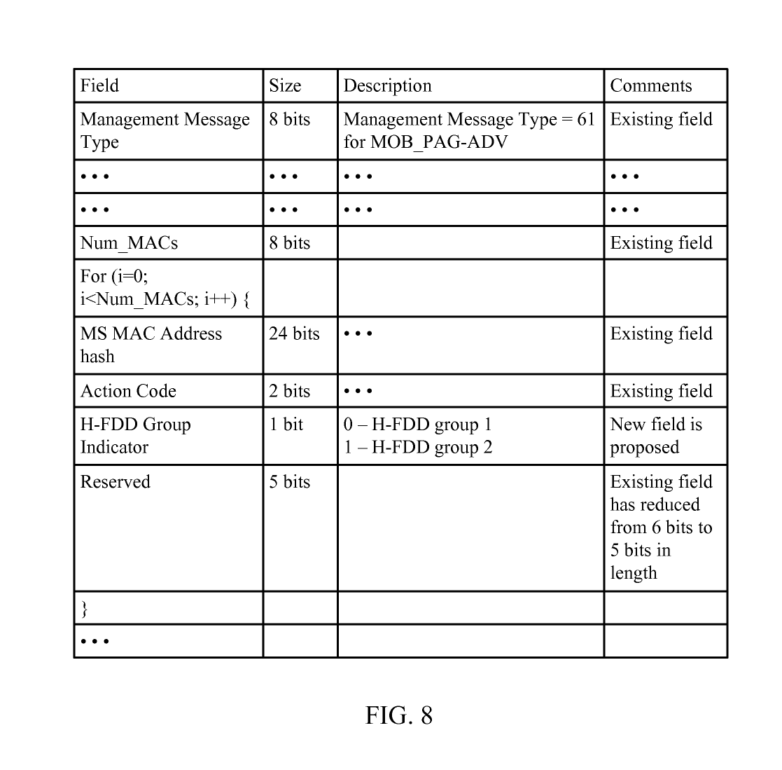

FIG. 8 illustrates an example table containing some of the current and proposed fields in the MOB_PAG-ADV message, in accordance with certain embodiments of the present disclosure. An MS may perform initial network entry or location update ranging on the resources as indicated by the H-FDD Group Indicator.

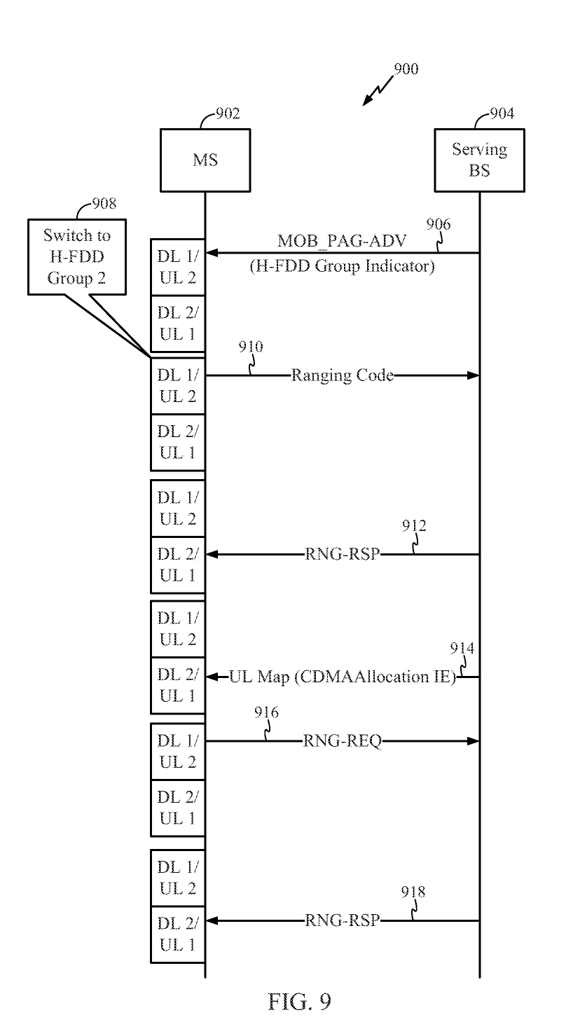

FIG. 9 illustrates an example procedure in which an MS may switch to H-FDD group 2 to send ranging code in the network reentry or location update procedure. The serving BS 904 sends a MOB_PAG-ADV (HFDD Group indicator) message 906 to the mobile station 902. The mobile station switches to the H-FDD group 2 908 and sends a ranging code 910 to the serving BS and receives a RNG-RSP message 912 from the serving BS. The MS receives a ULMAP (CDMA allocation IE) message 914 from the serving base station 904. The MS continues the ranging procedure with the serving BS by sending the RNG-REQ message 916 and receiving RNG-RSP message 918 from the serving BS.

For certain embodiments of the present disclosure, an MS may switch the group in an MS Initiated Network Reentry in Idle Mode. The serving BS may switch the H-FDD group for MS to continue the rest of ranging or network reentry procedure in the first ranging response (RNG-RSP). This is needed because the initial ranging process is anonymous (i.e., BS only knows the resource and frame used for the ranging code but BS does not which MS actually sent the ranging code). In order for MS to change quickly, BS can use the RNG-RSP to command MS to switch H-FDD group.

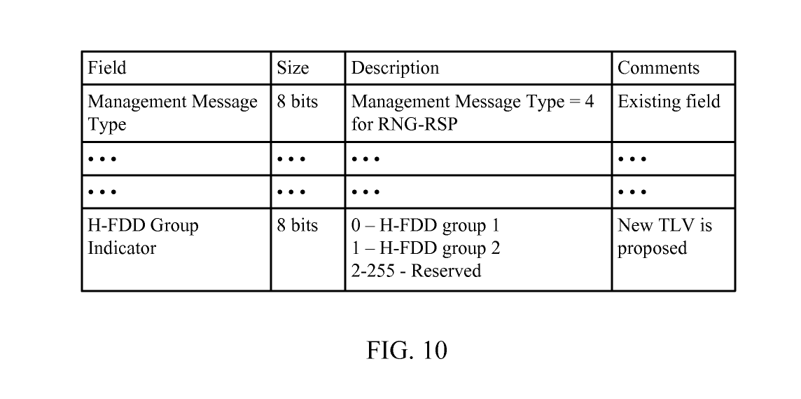

FIG. 10 illustrates an example table containing some of the current and proposed fields in the RNG-RSP message. When an MS detects the H-FDD Group Indicator, it switches to the H-FDD group indicated to continue the rest of ranging procedure for network reentry.

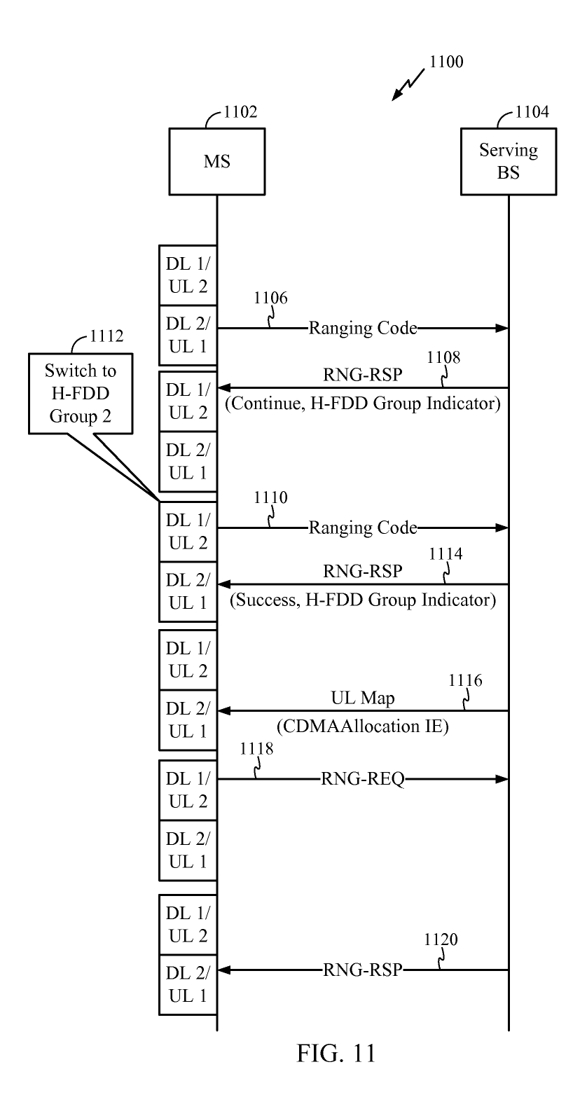

FIG. 11 illustrates a procedure in which an MS starts to use H-FDD group 1 to perform initial ranging and BS redirects to H-FDD group 2 in the first RNG-RSP which also requires MS to continue with ranging for verifying if the timing or power adjustment is done. Then MS switches to H-FDD group 2 to continue the rest ranging or network reentry procedure.

As illustrated in FIG. 11, the mobile station 1102 sends a ranging code 1106 to the serving BS 1104. The serving BS sends a RNG-RSP message 1108 to the MS that includes an H-FDD group indicator. The mobile station switches to the H-FDD group 2 1112 and sends a ranging code 1110 to the serving BS and receives a RNG-RSP message 1114 from the serving BS that includes a Success indication and H-FDD group indicator. The MS receives a ULMAP (CDMA allocation IE) message 1116 from the serving base station 1104. The MS continues the ranging procedure with the serving BS by sending the RNG-REQ message 1118 and receiving RNG-RSP message 1120 from the serving BS.

For certain embodiments of the present disclosure, an MS may change the group in association Ranging. The serving BS may command to switch H-FDD group for MS to perform association ranging for one or more target BS in the Mobile_Scanning Interval Allocation Response (MOB_SCN-RSP) message.

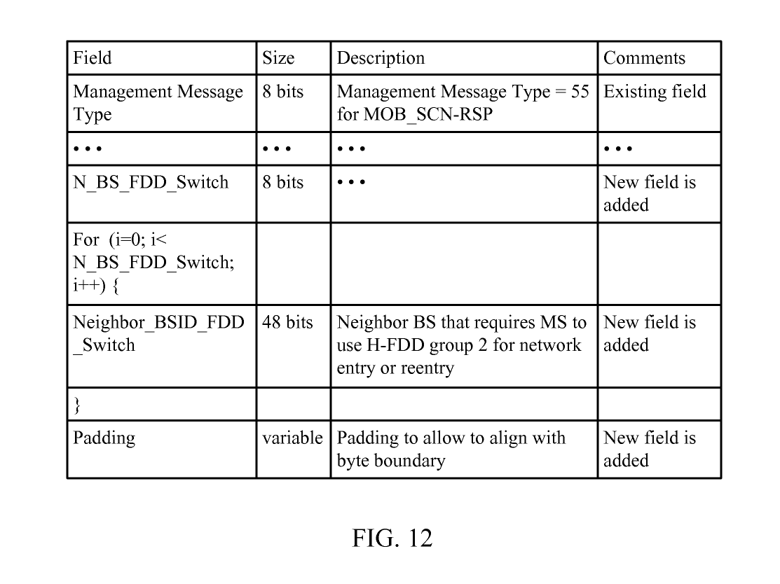

FIG. 12 illustrates an example table containing some of the current and proposed fields in the MOB_SCN-RSP message. Note that the field Neighbor_BSID_FDD_Switch is to indicate the neighbor BS that needs to use the H-FDD group 2 for association ranging. If it is not specified, an MS shall use H-FDD group 1 per the standards specification.

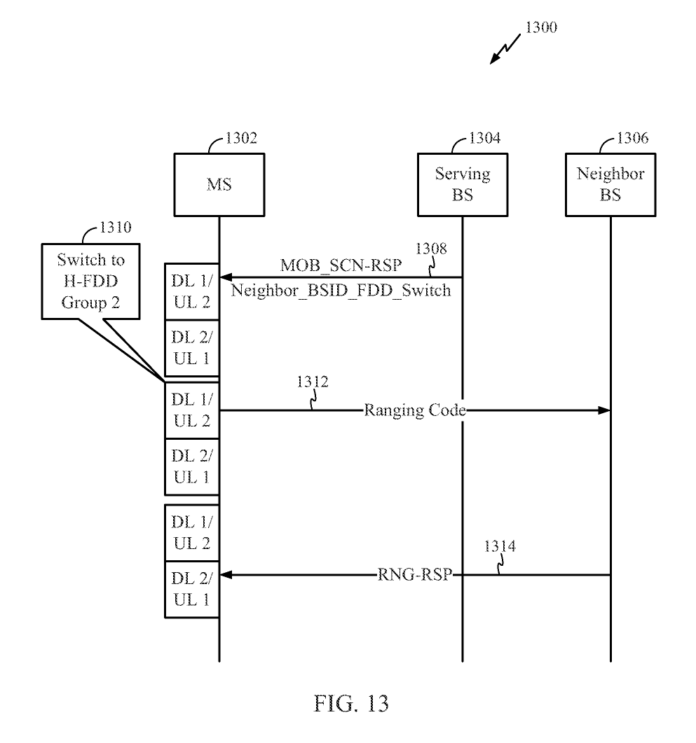

FIG. 13 illustrates an example procedure for switching the H-FDD group during association ranging, in accordance with certain embodiments of the present disclosure. The serving BS 1304 sends a MOB_SCN-RSP message 1308 with Neighbor_BSID-FDD_switch to the MS 1302. The MS switches to H-FDD group2 1310 and continues the ranging procedure with the neighbor BS 1306 by sending the RNG-REQ message 1312 and receiving RNG-RSP message 1314 from the neighbor BS 1306.

For certain embodiments of the present disclosure, an MS may change the group in initial ranging. The serving BS may send the H-FDD group index for MS to continue the rest of ranging or network reentry procedure in the first RNG-RSP. This is needed because the initial ranging process is anonymous (i.e., BS only know the resource and frame used for sending the ranging code but BS does not which MS actually sent the ranging code). In order for MS to change quickly, BS can use the RNG-RSP message to command MS to switch H-FDD group.

The RNG-RSP message should change similar to FIG. 10 in MS Initiated Network Reentry in Idle Mode.

The current disclosure allows the MS to quickly change an H-FDD group to perform ranging, initial network entry, and network reentry. The proposed techniques enable the BS to balance the ranging channel load between two H-FDD groups in WiMAX FDD systems and enhance performance and flexibility.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 502-510 illustrated in FIG. 5 correspond to means-plus-function blocks 502A-510A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
identifying a first frequency division duplex (FDD) group to communicate with the base station;
sending a request to a base station to join the first FDD group;
receiving a request from the base station to switch to a second FDD group;
switching to the second FDD group in response to the received request; and
continuing the communication with the base station in the second FDD group.

2. The method of claim 1, wherein the request from the base station to switch to a second FDD group is sent via a Mobile Paging Advertisement (MOB_PAG-ADV) message.

3. The method of claim 1, wherein the message from the base station to switch to a second FDD group is sent via a Base Station Handover Request (MOB_BSHO-REQ) message and a base station handover response (MOB_BSHO-RSP) message.

4. The method of claim 1, wherein the message from the base station to switch to a second FDD group is sent via at least one of: a Ranging Response (RNG-RSP) message and a Mobile_Scanning Interval Allocation Response (MOB_SCN-RSP) message.

5. The method of claim 1, wherein continuing to communicate with the base station comprises performing at least one of ranging, initial network entry or network reentry procedures.

6. An apparatus for wireless communications, comprising:
logic for identifying a first frequency division duplex (FDD) group to communicate with the base station;
logic for sending a request to a base station to join the first FDD group;
logic for receiving a request from the base station to switch to a second FDD group;
logic for switching to the second FDD group in response to the received request; and
logic for continuing the communication with the base station in the second FDD group.

7. The apparatus of claim 6, wherein the request from the base station to switch to a second FDD group is sent via a Mobile Paging Advertisement (MOB_PAG-ADV) message.

8. The apparatus of claim 6, wherein the message from the base station to switch to a second FDD group is sent via a Base Station Handover Request (MOB_BSHO-REQ) message and a base station handover response (MOB_BSHO-RSP) message.

9. The apparatus of claim 6, wherein the message from the base station to switch to a second FDD group is sent via at least one of: a Ranging Response (RNG-RSP) message and a Mobile_Scanning Interval Allocation Response (MOB_SCN-RSP) message.

10. The apparatus of claim 6, wherein the logic for continuing to communicate with the base station comprises logic for performing at least one of ranging, initial network entry or network reentry procedures.

11. An apparatus for wireless communications, comprising:
means for identifying a first frequency division duplex (FDD) group to communicate with the base station;
means for sending a request to a base station to join the first FDD group;
means for receiving a request from the base station to switch to a second FDD group;
means for switching to the second FDD group in response to the received request; and
means for continuing the communication with the base station in the second FDD group.

12. The apparatus of claim 11, wherein the request from the base station to switch to a second FDD group is sent via a Mobile Paging Advertisement (MOB_PAG-ADV) message.

13. The apparatus of claim 11, wherein the message from the base station to switch to a second FDD group is sent via a Base Station Handover Request (MOB_BSHO-REQ) message and a base station handover response (MOB_BSHO-RSP) message.

14. The apparatus of claim 11, wherein the message from the base station to switch to a second FDD group is sent via at least one of: a Ranging Response (RNG-RSP) message and a Mobile_Scanning Interval Allocation Response (MOB_SCN-RSP) message.

15. The apparatus of claim 11, wherein the means for continuing to communicate with the base station comprises means for performing at least one of ranging, initial network entry or network reentry procedures.

16. A computer-program storage apparatus for wireless communications, comprising one or more memories having instructions stored thereon, the instructions being executable by one or more processors and the instructions comprising:
instructions for identifying a first frequency division duplex (FDD) group to communicate with the base station;
instructions for sending a request to a base station to join the first FDD group;
instructions for receiving a request from the base station to switch to a second FDD group;
instructions for switching to the second FDD group in response to the received request; and
instructions for continuing the communication with the base station in the second FDD group.

17. The computer-program storage apparatus of claim 16, wherein the request from the base station to switch to a second FDD group is sent via a Mobile Paging Advertisement (MOB_PAG-ADV) message.

18. The computer-program storage apparatus of claim 16, wherein the message from the base station to switch to a second FDD group is sent via a Base Station Handover Request (MOB_BSHO-REQ) message and a base station handover response (MOB_BSHO-RSP) message.

19. The computer-program storage apparatus of claim 16, wherein the message from the base station to switch to a second FDD group is sent via at least one of: a Ranging Response (RNG-RSP) message and a Mobile_Scanning Interval Allocation Response (MOB_SCN-RSP) message.

20. The computer-program storage apparatus of claim 16, wherein the instructions for continuing to communicate with the base station comprise instructions for performing at least one of ranging, initial network entry or network reentry procedures.

21. A method for wireless communications by a base station (BS), comprising:
receiving a request to join a first frequency division duplex (FDD) group from a mobile station (MS);
notifying the MS to switch to a second FDD group if number of mobile stations in the first FDD group is larger than a threshold; and
communicating with the mobile station in the second FDD group.

22. The method of claim 21, wherein notifying the MS comprises notifying the MS to switch from a first FDD group to a second FDD group via a Mobile Paging Advertisement (MOB_PAG-ADV) message.

23. The method of claim 21, wherein notifying the MS comprises notifying the MS to switch from a first FDD group to a second FDD group via a Base Station Handover Request (MOB_BSHO-REQ) message and a Base Station Handover Response (MOB_BSHO-RSP) message.

24. The method of claim 21, wherein notifying the MS comprises notifying the MS to switch from a first FDD group to a second FDD group via a Ranging Response (RNG-RSP) message.

25. The method of claim 21, wherein notifying the MS comprises notifying the MS to switch from a first FDD group to a second FDD group via a Mobile Scanning Interval Allocation Response (MOB_SCN-RSP) message.

26. An apparatus for wireless communications by a base station (BS), comprising:
logic for receiving a request to join a first frequency division duplex (FDD) group from a mobile station (MS);
logic for notifying the MS to switch to a second FDD group if number of mobile stations in the first FDD group is larger than a threshold; and
logic for communicating with the mobile station in the second FDD group.

27. The apparatus of claim 26, wherein the logic for notifying the MS comprises logic for notifying the MS to switch from a first FDD group to a second FDD group via a Mobile Paging Advertisement (MOB_PAG-ADV) message.

28. The apparatus of claim 26, wherein the logic for notifying the MS comprises logic for notifying the MS to switch from a first FDD group to a second FDD group via a Base Station Handover Request (MOB_BSHO-REQ) message and a Base Station Handover Response (MOB_BSHO-RSP) message.

29. The apparatus of claim 26, wherein the logic for notifying the MS comprises logic for notifying the MS to switch from a first FDD group to a second FDD group via a Ranging Response (RNG-RSP) message.

30. The apparatus of claim 26, wherein the logic for notifying the MS comprises logic for notifying the MS to switch from a first FDD group to a second FDD group via a Mobile_Scanning Interval Allocation Response (MOB_SCN-RSP) message.

31. An apparatus for wireless communications by a base station (BS), comprising:
means for receiving a request to join a first frequency division duplex (FDD) group from a mobile station (MS);
means for notifying the MS to switch to a second FDD group if number of mobile stations in the first FDD group is larger than a threshold; and
means for communicating with the mobile station in the second FDD group.

32. The apparatus of claim 31, wherein the means for notifying the MS comprises means for notifying the MS to switch from a first FDD group to a second FDD group via a Mobile Paging Advertisement (MOB_PAG-ADV) message.

33. The apparatus of claim 31, wherein the means for notifying the MS comprises means for notifying the MS to switch from a first FDD group to a second FDD group via a Base Station Handover Request (MOB_BSHO-REQ) message and a Base Station Handover Response (MOB_BSHO-RSP) message.

34. The apparatus of claim 31, wherein the means for notifying the MS comprises means for notifying the MS to switch from a first FDD group to a second FDD group via a Ranging Response (RNG-RSP) message.

35. The apparatus of claim 31, wherein the means for notifying the MS comprises means for notifying the MS to switch from a first FDD group to a second FDD group via a Mobile_Scanning Interval Allocation Response (MOB_SCN-RSP) message.

36. A computer-program storage apparatus for wireless communications by a base station (BS), comprising one or more memories having instructions stored thereon, the instructions being executable by one or more processors and the instructions comprising:
receiving a request to join a first frequency division duplex (FDD) group from a mobile station (MS);
notifying the MS to switch to a second FDD group if number of mobile stations in the first FDD group is larger than a threshold; and
communicating with the mobile station in the second FDD group.

37. The computer-program storage apparatus of claim 36, wherein the instructions for notifying the MS comprise instructions for notifying the MS to switch from a first FDD group to a second FDD group via a Mobile Paging Advertisement (MOB_PAG-ADV) message.

38. The computer-program storage apparatus of claim 36, wherein the instructions for notifying the MS comprise instructions for notifying the MS to switch from a first FDD group to a second FDD group via a Base Station Handover Request (MOB_BSHO-REQ) message and a Base Station Handover Response (MOB_BSHO-RSP) message.

39. The computer-program storage apparatus of claim 36, wherein the instructions for notifying the MS comprise instructions for notifying the MS to switch from a first FDD group to a second FDD group via a Ranging Response (RNG-RSP) message.

40. The computer-program storage apparatus of claim 36, wherein the instructions for notifying the MS comprise instructions for notifying the MS to switch from a first FDD group to a second FDD group via a Mobile_Scanning Interval Allocation Response (MOB_SCN-RSP) message.
